(19) United States
(12) Patent Application Publication
(10) Pub. No.: US 2014/0007750 A1
(43) Pub. Date: Jan. 9, 2014

(54) PUNCHER HAVING A SCRAP-RELEASING CAPABILITY IN A ROTATING MANNER

(71) Applicant: SDI CORPORATION, Chang Hua (TW)

(72) Inventors: Chih-Wei Hsu, Chang Hua (TW); Chien-Lung Wu, Chang Hua (TW)

(73) Assignee: SDI CORPORATION, Chang Hua (TW)

(21) Appl. No.: 13/800,031

(22) Filed: Mar. 13, 2013

(30) Foreign Application Priority Data
Jul. 4, 2012 (TW) 101124013

(51) Int. Cl. B26F 1/02

(52) U.S. Cl. CPC B26F 1/02
USPC 83/167

(57) ABSTRACT

A puncher has a base, a pressing lever and two cutters. The base has a base body, a bottom cover, at least one scrap-receiving space and at least one scrap-releasing hole. The bottom cover is combined rotatably with the base body. The at least one scrap-receiving space is formed between the base body and the bottom cover. The at least one scrap-releasing hole is defined in the base and selectively communicates with the at least one scrap-receiving space after the base body being rotated relative to the bottom cover. The pressing lever is pivotally connected to the base. The cutters are mounted on the base and are capable of being driven by the pressing lever and longitudinally moving relative to the base. Accordingly, a puncher having a scrap-releasing capability in a rotating manner to release scraps from the puncher easily and conveniently is provided.

### BACKGROUND OF THE INVENTION

1. Field of the Invention

The present invention relates to a puncher, and more particularly to a puncher having a scrap-releasing capability in a rotating manner.

2. Description of Related Art

With reference to FIG. 12, a conventional puncher has a base 40, a pressing lever 42, two cutters and a bottom cover 44. The base 40 has a chamber defined in the bottom of the base 40. The pressing lever 42 is pivotally connected to the base 40. The cutters are mounted on the base 40 and are driven by the pressing lever 42. The bottom cover 44 is mounted on the bottom of the base 40 to close the chamber. To punch pieces of paper, the paper sheets are inserted into a base recess formed between the base 40 and the pressing lever 42, and the pressing lever 42 is pressed to pivot relative to the base 40. Consequently, the cutters are driven to punch the paper sheets, and scraps punched from the paper sheets are received in the chamber of the base 40.

After a period of use, the bottom cover 44 has to be removed from the base 40 to release the scraps from the chamber. However, the bottom cover 44 of the conventional puncher is mounted on the base 40 in an engagement manner, the bottom cover 44 has to be lifted or taken apart from the base 40 with a large force. The large force easily causes inconvenience in removing the bottom cover 44 from the base 40, and the scraps in the chamber easily spread to cause inconvenience in cleaning.

To overcome the shortcomings, the present invention tends to provide a puncher to mitigate the aforementioned problems.

### SUMMARY OF THE INVENTION

The main objective of the invention is to provide a puncher having a scrap-releasing capability in a rotating manner to release scraps from the puncher easily and conveniently.

A puncher has a base, a pressing lever and two cutters. The base has a base body, a bottom cover, at least one scrap-receiving space and at least one scrap-releasing hole. The bottom cover is combined rotatably with the base body. The at least one scrap-receiving space is formed between the base body and the bottom cover. The at least one scrap-releasing hole is defined in the base and selectively communicates with the at least one scrap-receiving space after the base body being rotated relative to the bottom cover. The pressing lever is pivotally connected to the base. The cutters are mounted on the base and are capable of being driven by the pressing lever and longitudinally moving relative to the base.

Accordingly, when the base body or the bottom cover is relatively, the at least one scrap-receiving space selectively communicates with the at least one scrap-releasing hole. Thus, the scraps can be released from the at least one scrap-receiving space from the at least one scrap-releasing hole. Accordingly, to remove the bottom cover from the base body is unnecessary, so to release scraps from the puncher is easy and convenient. In addition, the scraps can be kept from spreading and can be concentrated to enable a user to clean the scraps conveniently.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a puncher in accordance with the present invention;

FIG. 2 is a partially exploded perspective view of the puncher in FIG. 1;

FIG. 3 is a cross sectional top view of the puncher in FIG. 1;

FIG. 4 is a perspective view in partial section of the puncher in FIG. 1;

FIG. 5 is an operational cross sectional top view of the puncher in FIG. 1 showing that the puncher is in a scrap-releasing condition;

FIG. 6 is an operational perspective view in partial section of the puncher in FIG. 1 showing that the puncher is in a scrap-releasing condition;

FIG. 7 is a perspective view of a second embodiment of a puncher in accordance with the present invention;

FIG. 8 is a partially exploded perspective view of the puncher in FIG. 7;

FIG. 9 is a cross sectional top view of the puncher in FIG. 7;

FIG. 10 is an operational cross sectional top view of the puncher in FIG. 7 showing that the puncher is in a scrap-releasing condition;

FIG. 11 is another operational top view in partial section of the puncher in FIG. 7 showing that the puncher is in a scrap-releasing condition; and

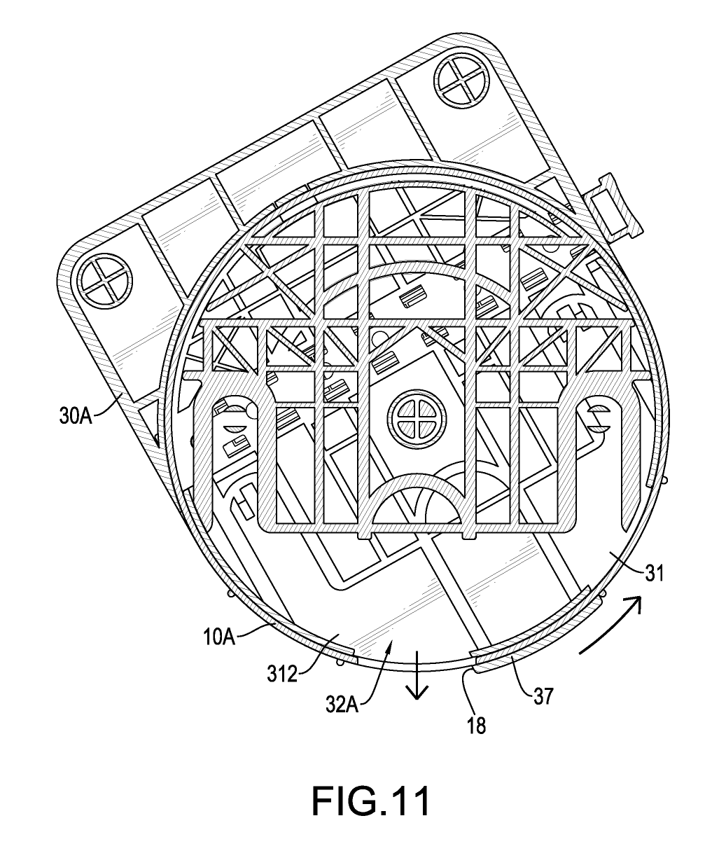

FIG. 12 is a perspective view of a conventional puncher in accordance with the prior art.

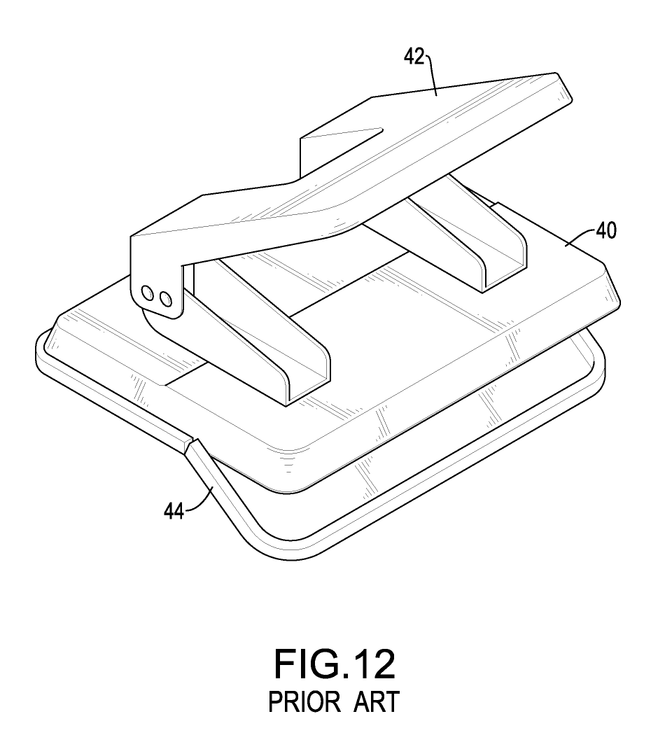

### DETAILED DESCRIPTION OF PREFERRED EMBODIMENT

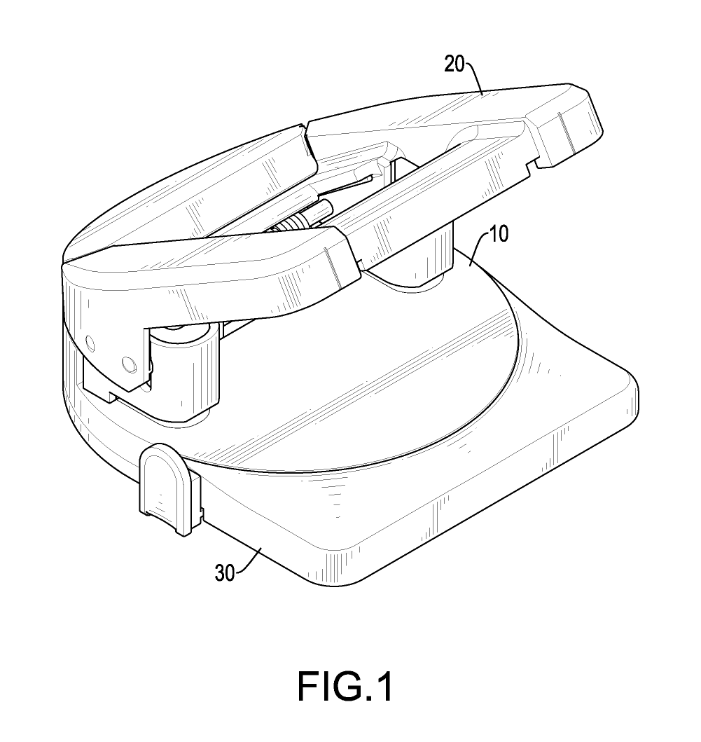

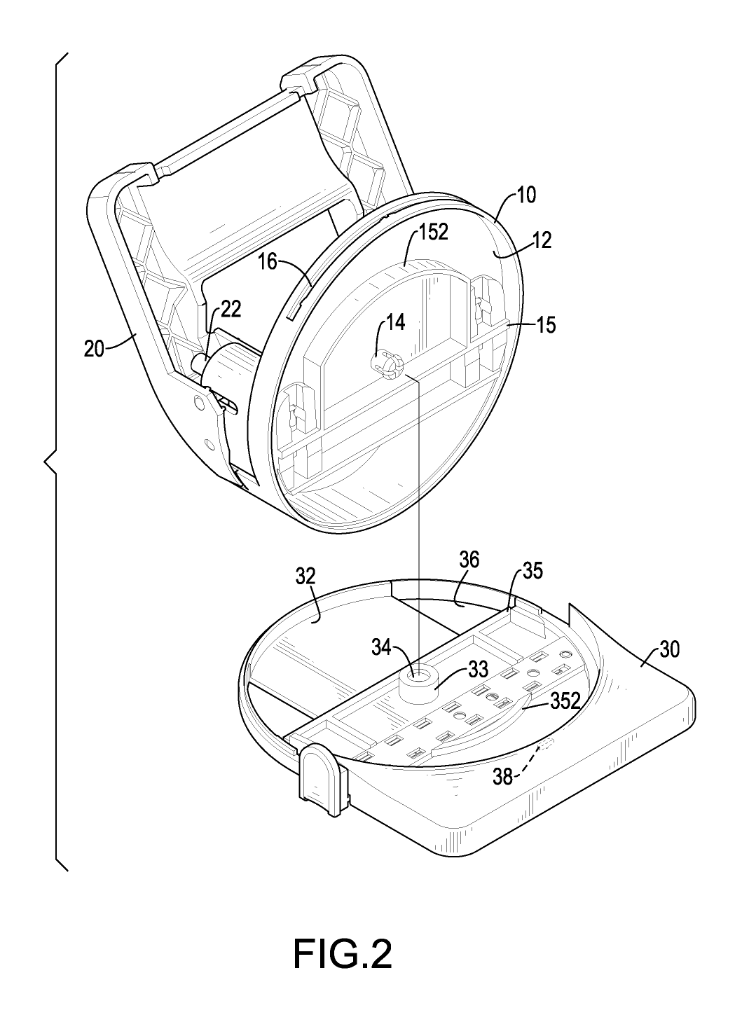

With reference to FIGS. 1 and 2, a first embodiment of a puncher in accordance with the present invention mainly comprises a base, a pressing lever 20 and two cutters 22. The pressing lever 20 is pivotally connected to the base. The cutters 22 are mounted on the base and are capable of being driven by the pressing lever 20 and longitudinally moving relative to the base. The structural relationship between the base, the pressing lever 20 and the cutters 22 may be conventional, so detail description thereof is omitted.

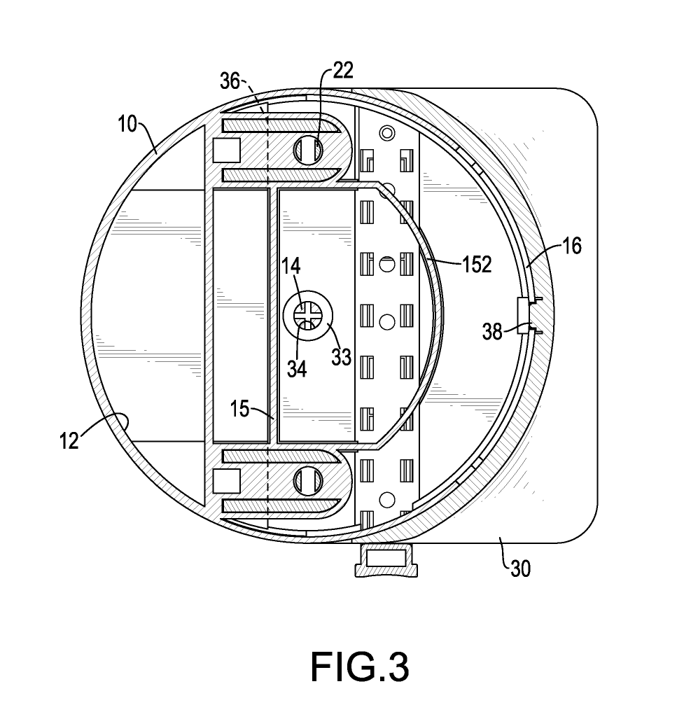

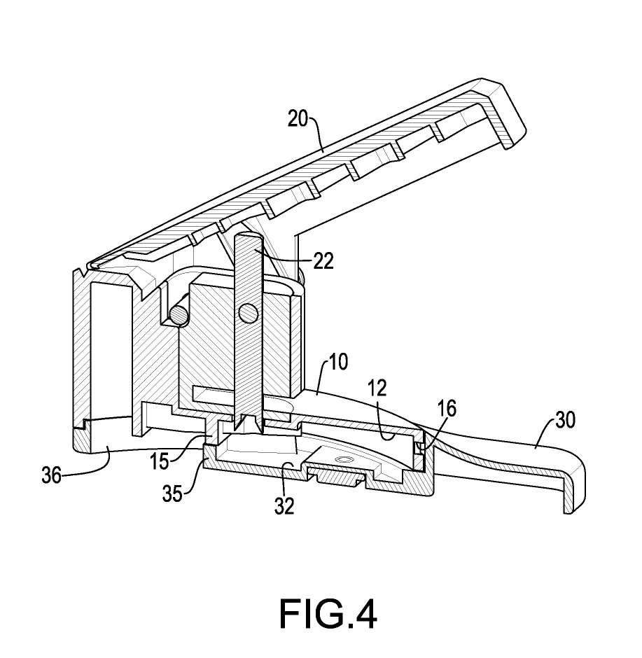

With further reference to FIGS. 3 and 4, the base has a base body 10 and a bottom cover 30 The base body 10 is combined rotatably with the bottom cover 30 and may have a round cross section. A chamber 12 is defined in a bottom of the base body 10. The bottom cover 30 has a top and a round receiving recess 32 defined in the top of the bottom cover 30. A scrap-receiving space is defined between the chamber 12 of the base body 10 and the receiving recess 32 of the bottom cover 30 and may be an enclosed space. The base body 10 further has a baffle rib 15 formed on the bottom surface of the chamber 12 to divide the chamber 12 into two segments. The cutters 22 corresponds to the same segment of the chamber 12, and the segment of the chamber 12 corresponding to the cutters 22 is defined as a first segment and the other segment is defined as a second segment. The bottom cover 30 further has a baffle rib 35 formed on the bottom surface of the receiving recess 32 and abutting with the baffle rib 15 on the base body 10. With the baffle rib 35 on the bottom cover 30, the receiving recess 32 is divided into two segments including a first segment and a second segment corresponding respectively to the first segment and the second segment of the chamber 12 in the base body 10. The scrap-receiving space between the chamber 12 and the receiving recess 32 is composed of the first segment of the chamber 12 and the first segment of the receiving recess 32 to receive the scraps punched by the cutters 22.

In addition, the base body 10 has a U-shaped baffle strip 152 formed on and protruding from the baffle rib 15 and located in the first segment of the chamber 12. The bottom cover 30 has a U-shaped baffle strip 352 formed on and protruding from the baffle rib 35, located in the first segment of the receiving recess 32 and abutting with the baffle strip 152 on the base body 10 to form the scrap-receiving space as U-shaped.

A combination assembly is disposed on the centers of the base body 10 and the receiving recess 32 to rotatably combine the base body 10 with the bottom cover 30. The combination assembly comprises a combining post 14 and a combining recess 34 rotatably combining with the combining post 14. The combining post 14 may be resilient, may protrude from the bottom surface of the chamber 12 and may be disposed on the center of the base body 10. The combining recess 34 is disposed in the center of the receiving recess 32. In addition, a combining column 33 is formed on and protrudes from the center of the receiving recess 32, and the combining recess 34 is defined in the top of the combining column 33. The combining post 14 comprises multiple resilient combining hooks formed on the end of the combining post 14 and rotatably hooking on the inner surface edge of the combining recess 34. The amount of the resilient combining hooks may be 4 as shown, two or any other possible number and is not limited in this invention. With the engagement between the combining post 14 and the combining recess 34, the base body 10 is rotatable relative to the bottom cover 30. Alternatively, the combining post 14 may be formed on the bottom cover 30, and the combining recess 34 may be defined in the base body 10 to enable the base body 10 to be rotatable relative to the bottom cover 30. Furthermore, the combining post 14 and the combining recess 34 may be located respectively in the first segments of the chamber 12 and the receiving recess 32 or may be located respectively in the second segments of the chamber 12 and the receiving recess 32.

The bottom cover 30 has at least one scrap-releasing hole 36 defined in the bottom cover 30 and selectively communicating with the scrap-receiving space when the base body 10 is rotated relative to the bottom cover 30. Preferably, two scrap-releasing holes 36 are implemented and defined in the bottom cover 30 and are located at the second segment of the receiving recess 32 in the bottom cover 30. Accordingly, the scraps received in the scrap-receiving space can be prevented from dropping off from scrap-releasing holes 36 directly with the blocking effect provided by the baffle rib 35.

In addition, the base body 10 is reciprocatively rotatable relative to the bottom cover 30 at an angular range. Preferably, the angular range between the base body 10 being rotatable relative to the bottom cover 30 is 30° in curvature in each clockwise and counterclockwise rotating directions. The two scrap-releasing holes 36 are located respectively at two ends of the angular range of the base body 10 being rotatable relative to the bottom cover 30. In addition, the base body 10 has a track groove 16 with an arc length defined in the base body 10, and the bottom cover 30 has a limiting protrusion 38 formed on the bottom cover 30 and slidably mounted in the track groove 16. With the arrangement of the track groove 16 and the limiting protrusion 38, the base body 10 can be limited to be rotatable relative to the bottom cover 30 at a specific angular range and the combination between base body 10 and the bottom cover 30 can be enhanced to prevent from being damaged when a punching process is proceeding. Alternatively, the track groove 16 may be defined in the bottom cover 30, and the limiting protrusion 38 is formed on the base body 10 to achieve the same function and objective.

In use, paper sheets are put on the base body 10 to make edges of the paper sheet corresponding to the cutters 22, and the pressing lever 20 is pressed and pivoted relative to the base body 10. Accordingly, the pressing lever 20 pushes the cutters 22 to move downward relative to the base body 10 and to punch holes in the paper sheets, and the scraps punched from the paper sheets drop into and are received in the scrap-receiving space.

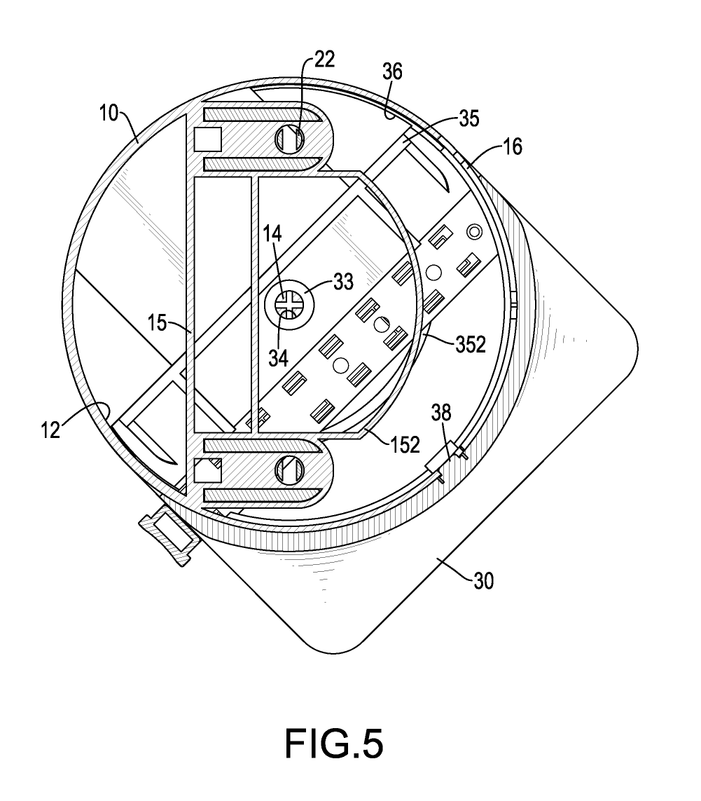

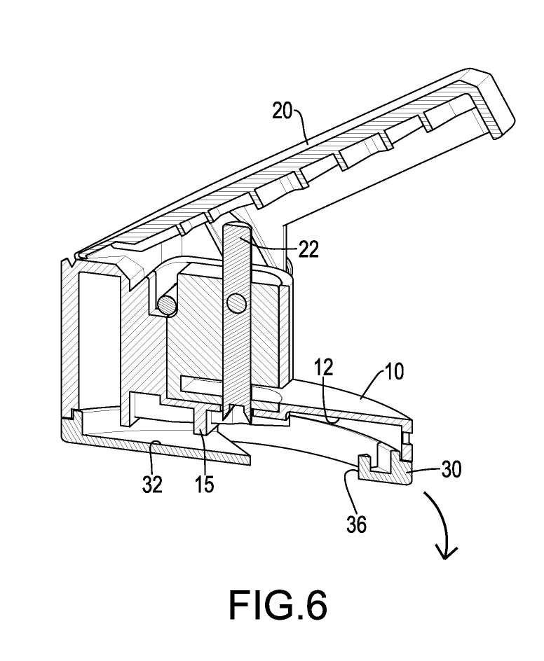

To release the scraps from the scrap-receiving space, the base body 10 or the bottom cover 30 is rotated to communicate the scrap-receiving space with the scrap-releasing holes 36. With reference to FIGS. 5 and 6, the scraps in the scrap-receiving space can be poured out from the scrap-releasing holes 36 in corporation with slightly inclining the puncher. When two scrap-releasing holes 36 are implemented and the base body 10 is rotatable relative to the bottom cover 30 at a specific angular range, the base body 10 can be rotated in clockwise or counterclockwise to communicate the two scrap-releasing holes 36 respectively and alternatively with the scrap-receiving space. Accordingly, to remove the bottom cover 30 from the base body 10 is unnecessary for releasing scraps from the puncher, and to release scraps from the puncher is easy and convenient. This also can prevent scraps from spreading and can concentrate the scraps to enable a user to clean the scraps conveniently.

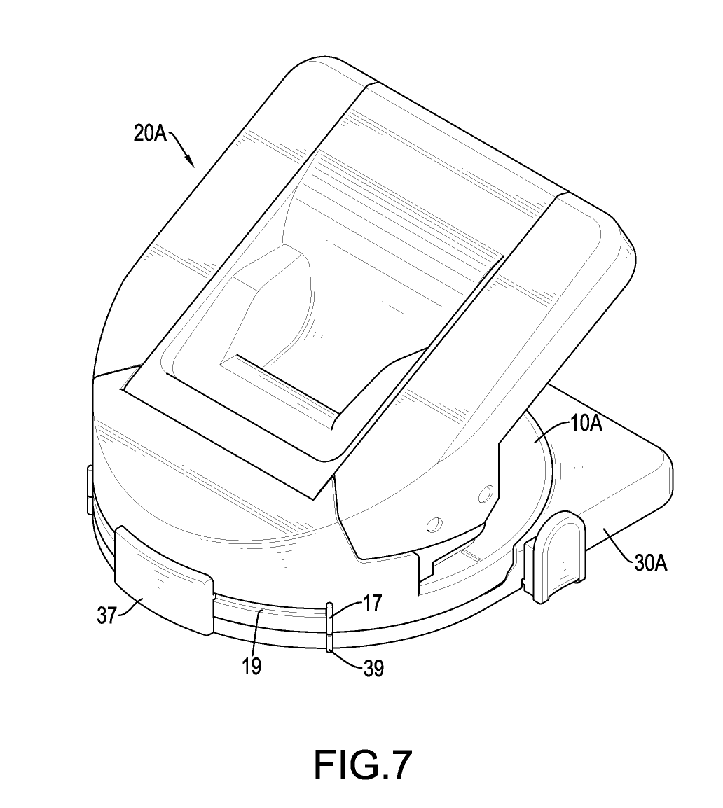

With reference to FIGS. 7 to 9, a second embodiment of a puncher in accordance with the present invention comprises a base, a pressing lever 20A and two cutters and has a structure similar to that of the first embodiment. In the second embodiment, the base body 10A is reciprocatively rotatable relative to the bottom cover 30A at an angular range of 90° in curvature in each clockwise and counterclockwise rotating directions. Preferably, the angular range between the base body 10A being rotatable relative to the bottom cover 30A is 30° in curvature in each clockwise and counterclockwise rotating directions. Two scrap-receiving spaces 31,312 communicating with each other are defined between the base body 10A and the bottom cover 30A. A curved closing tab 37 is formed on the periphery of the bottom cover 30A and located between the scrap-receiving spaces 31,312. The combining post 14A and the combining recess 34A on the base body 10A and the bottom cover 30A are located on the chamber 12A and the receiving recess 32A at positions beside the scrap-receiving spaces 31,312.

In the second embodiment, a single scrap-releasing hole 18 is implemented, is defined in the periphery of the base body 10A and corresponds to and is closed by the closing tab 37.

Is use, when paper sheets are put on the base body 10A and the pressing lever 20A is pressed, the paper sheets are punched by the cutters and scraps punched from the paper sheets are received in the scrap-receiving spaces 31,312.

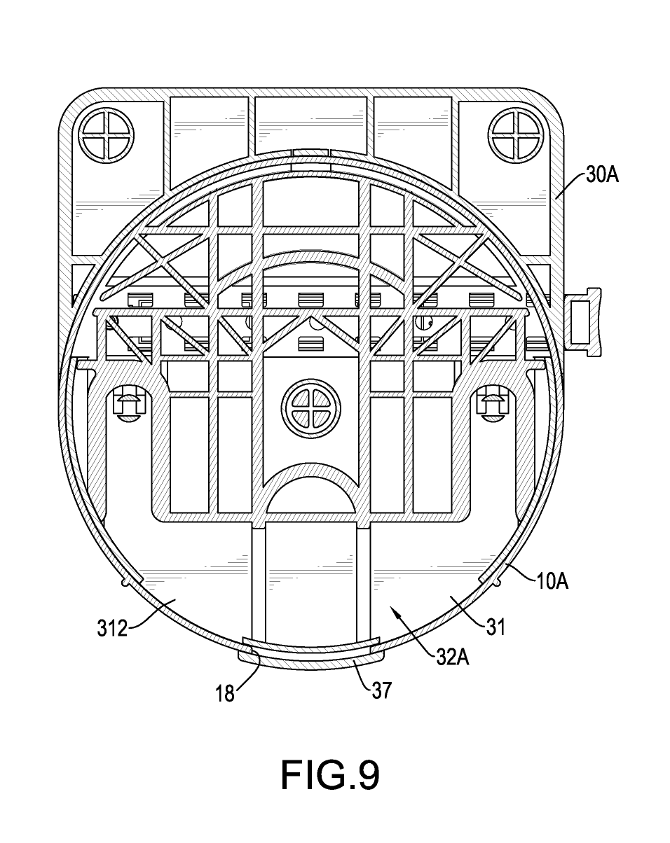

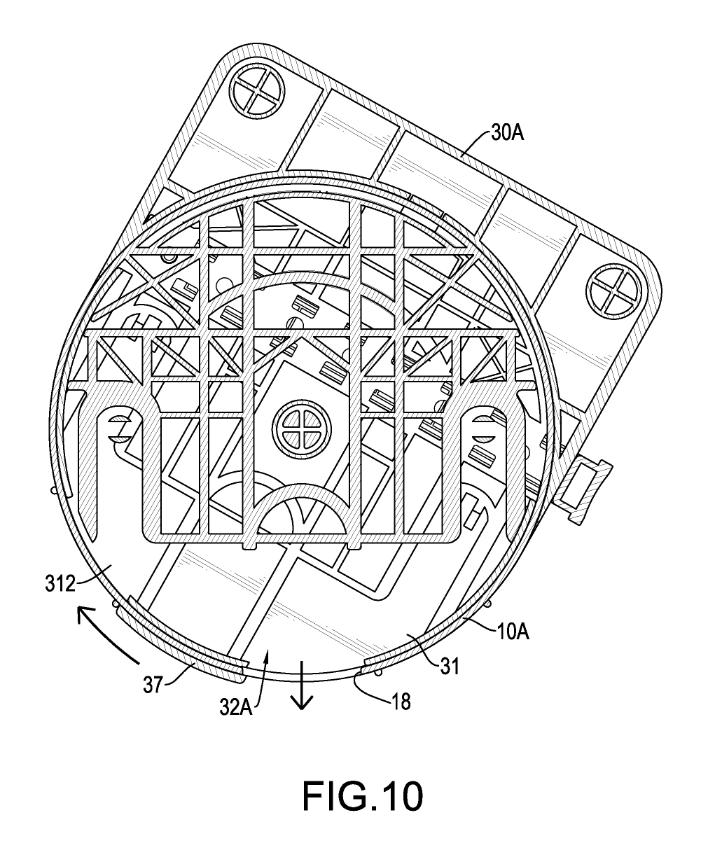

To release the scraps from the scrap-receiving spaces 31,312, the base body 10A or the bottom cover 30A is rotated in clockwise or counterclockwise. Consequently, the closing tab 37 will leave the position where closes the scrap-releasing hole 18 of the base body 10A to enable the scrap-releasing hole 18 to communicate with any one of the scrap-receiving spaces 31,312. With reference to FIGS. 9 and 10, the scraps in the scrap-receiving spaces 31,312 can be poured out from the scrap-releasing hole 18 in corporation with slightly inclining the puncher. Accordingly, the scraps can be easily and conveniently released from the scrap-receiving spaces 31,312 via the scrap-releasing hole 18 after relatively rotating the base body 10A to the bottom cover 30A.

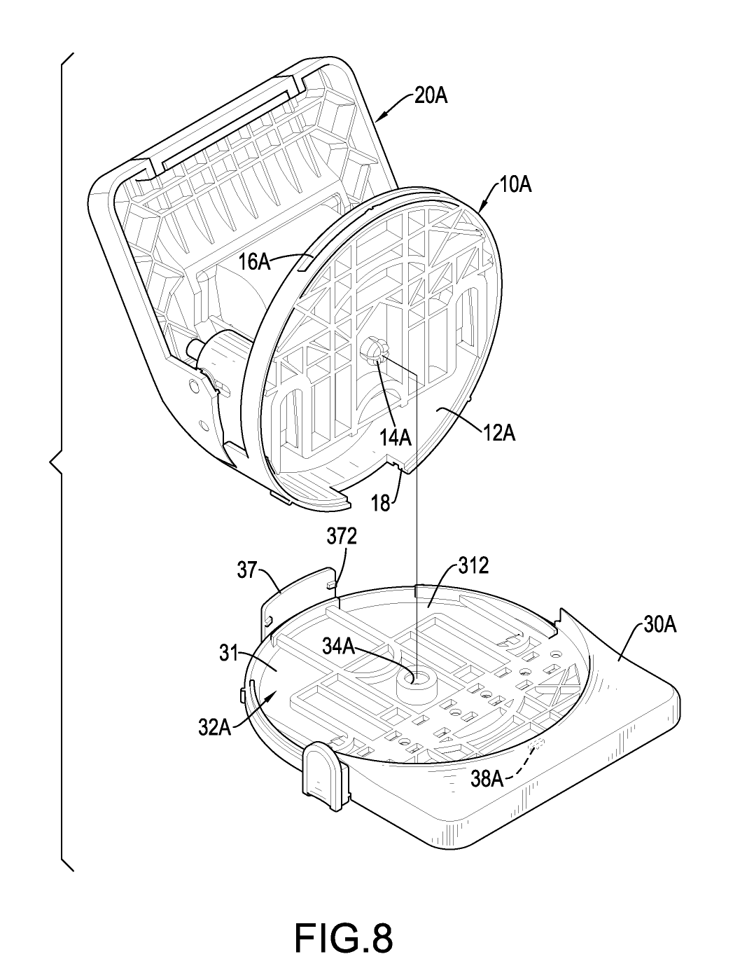

With reference to FIGS. 7 and 8, the closing tab 37 has at least one guiding block 372 formed on and protruding from the inner surface of the closing tab 37. The base body 10A has a guiding groove 19 formed in the periphery of the base body 10A, extending from at least one side of the scrap-releasing hole 18 and slidably holding the at least one guiding block 372 inside. The base body 10A further has at least one limiting rib 17 formed respectively on at least one end of the guiding groove 19. The bottom cover 30A has at least one aligning rib 39 formed on the bottom cover 30A at position respectively corresponding to and selectively aligning with the at least one limiting rib 17 on the base body 10A. Preferably, two guiding blocks 372 are implemented and are located respectively at two ends of the inner surface of the closing tab 37. The guiding groove 19 extends from two sides of the scrap-releasing hole 18, and two limiting ribs 17 and two aligning ribs 39 are implemented and correspond respectively to two ends of the guiding groove 19. With the arrangement of the guiding groove 19 and the guiding blocks 372, the rotation between the base body 10A and the bottom cover 30A is smooth and the combination between the base body 10A and the bottom cover 30A can be kept from being damaged when the punching process is proceeding. In addition, with the abutment between one of the guiding blocks 372 with one of the ends of the guiding groove 19, the angular range of the relative rotation between the base body 10A and the bottom cover 30A is limited. With the arrangement of the limiting ribs 17, the angular range of the relative rotation between the base body 10A and the bottom cover 30A for releasing scraps is also limited by the abutment of the closing tab 37 with one of the limiting ribs 17. When the limiting ribs 17 align respectively with the aligning ribs 39, the closing tab 37 completely closes the scrap-releasing hole 18. Thus, a position-aligning effect is provided to the user for operating the puncher to close the scrap-releasing hole 18. Preferably, with reference to FIG. 8, a track groove 16A and a limiting protrusion 38A are formed respectively on the base body 10A and the bottom cover 30A at sides opposite to the guiding groove 19 and the guiding blocks 372, such that force applied to and born by the structure of the puncher is even while the punching process is proceeding.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A puncher comprising:
a base having
a base body;
a bottom cover combined rotatably with the base body;
at least one scrap-receiving space formed between the base body and the bottom cover;
at least one scrap-releasing hole defined in the base and selectively communicating with the at least one scrap-receiving space after the base body being rotated relative to the bottom cover;
a pressing lever pivotally connected to the base; and
two cutters mounted on the base and being capable of being driven by the pressing lever and longitudinally moving relative to the base.

2. The puncher as claimed in claim 1, wherein the at least one scrap-releasing hole is formed in the bottom cover.

3. The puncher as claimed in claim 2, wherein
the base body is reciprocatively rotatable relative to the bottom cover at an angular range; and
two scrap-releasing holes are implemented, are defined in the bottom cover and are located respectively at two ends of the angular range of the base body being rotatable relative to the bottom cover.

4. The puncher as claimed in claim 3, wherein
the base body has a track groove defined in the base body; and
the bottom cover has a limiting protrusion formed on the bottom cover and slidably mounted in the track groove.

5. The puncher as claimed in claim 4, wherein the angular range between the base body being rotatable relative to the bottom cover is 30° in curvature in each clockwise and counterclockwise rotating directions.

6. The puncher as claimed in claim 5, wherein
the bottom cover has a top and a round receiving recess defined in the top of the bottom cover and having a center;
the base body has a round cross section and having a center corresponding to the center of the receiving recess; and
a combination assembly is disposed on the centers of the base body and the receiving recess to rotatably combine the base body with the bottom cover.

7. The puncher as claimed in claim 6, wherein the combination assembly comprises a combining post and a combining recess rotatably combining with the combining post.

8. The puncher as claimed in claim 7, wherein the combining post is resilient and comprises an end and multiple resilient combining hooks formed on the end of the combining post and hooking on an inner surface edge of the combining recess.

9. The puncher as claimed in claim 8, wherein
the base body has
a chamber defined in a bottom of the base body and having a bottom surface; and
a baffle rib formed on the bottom surface of the chamber to divide the chamber into a first segment and a second segment;
the cutters correspond to the first segment of the chamber in the base body;
the bottom cover further has
a baffle rib formed on a bottom surface of the receiving recess and abutting with the baffle rib on the base body to divide the receiving recess into a first segment and a second segment corresponding respectively to the first segment and the second segment of the chamber in the base body; and
a scrap-receiving space is implemented and composed of the first segment of the chamber and the first segment of the receiving recess.

10. The puncher as claimed in claim 9, wherein the combining post and the combining recess are disposed respectively in the first segments of the chamber and the receiving recess.

11. The puncher as claimed in claim 10, wherein the scrap-releasing holes are located in the second segment of the receiving recess.

12. The puncher as claimed in claim 1, wherein
the bottom cover has a top and a round receiving recess defined in the top of the bottom cover and having a center;
the base body has a round cross section and having a center corresponding to the center of the receiving recess; and
a combination assembly is disposed on the centers of the base body and the receiving recess to rotatably combine the base body with the bottom cover.

13. The puncher as claimed in claim 12, wherein the combination assembly comprises a combining post and a combining recess rotatably combining with the combining post.

14. The puncher as claimed in claim 13, wherein the combining post is resilient and comprises an end and multiple resilient combining hooks formed on the end of the combining post and hooking on an inner surface edge of the combining recess.

15. The puncher as claimed in claim 14, wherein
the combining post is disposed on a bottom of the base body; and
the combining recess is disposed in the receiving recess in the bottom cover.

16. The puncher as claimed in claim 15, wherein
the receiving recess has a combining column formed on and protruding from the center of the receiving recess; and
the combining recess is defined in a top of the combining column.

17. The puncher as claimed in claim 1, wherein
the base body has
a chamber defined in a bottom of the base body and having a bottom surface; and
a baffle rib formed on the bottom surface of the chamber to divide the chamber into a first segment and a second segment;
the cutters correspond to the first segment of the chamber in the base body;
the bottom cover further has
a baffle rib formed on a bottom surface of the receiving recess and abutting with the baffle rib on the base body to divide the receiving recess into a first segment and a second segment corresponding respectively to the first segment and the second segment of the chamber in the base body; and
a scrap-receiving space is implemented and composed of the first segment of the chamber and the first segment of the receiving recess.

18. The puncher as claimed in claim 17, wherein
the base body has a U-shaped baffle strip formed on and protruding from the base body and located in the first segment of the chamber;
the bottom cover has a U-shaped baffle strip formed on and protruding from the bottom cover, located in the first segment of the receiving recess and abutting with the baffle strip on the base body to form the scrap-receiving space as U-shaped.

19. The puncher as claimed in claim 18, wherein the at least one scrap-releasing hole is located in the second segment of the receiving recess.

20. The puncher as claimed in claim 1, wherein the at least one scrap-releasing hole is formed in the base body.

21. The puncher as claimed in claim 20, wherein the bottom cover has at least one closing tab formed on a periphery of the bottom cover to close the at least one scrap-releasing hole.

22. The puncher as claimed in claim 21, wherein
the base body has a track groove defined in the base body; and
the bottom cover has a limiting protrusion formed on the bottom cover and slidably mounted in the track groove.

23. The puncher as claimed in claim 22, wherein the base body is rotatable relative to the bottom cover at an angular range of 90° in curvature in each clockwise and counterclockwise rotating directions.

24. The puncher as claimed in claim 23, wherein the angular range between the base body being rotatable relative to the bottom cover is 30° in curvature in each clockwise and counterclockwise rotating directions.

25. The puncher as claimed in claim 24, wherein
the bottom cover has a top and a round receiving recess defined in the top of the bottom cover and having a center;
the at least one scrap-receiving space is located in the receiving recess;
the base body has a round cross section and having a center corresponding to the center of the receiving recess; and
a combination assembly is disposed on the centers of the base body and the receiving recess to rotatably combine the base body with the bottom cover.

26. The puncher as claimed in claim 25, wherein the combination assembly comprises a combining post and a combining recess rotatably combining with the combining post.

27. The puncher as claimed in claim 26, wherein the combining post is resilient and comprises an end and multiple resilient combining hooks formed on the end of the combining post and hooking on an inner surface edge of the combining recess.

28. The puncher as claimed in claim 27, wherein
the combining post is disposed on a bottom of the base body; and
the combining recess is disposed in the receiving recess in the bottom cover.

29. The puncher as claimed in claim 28, wherein
the receiving recess has a combining column formed on and protruding from the center of the receiving recess; and
the combining recess is defined in a top of the combining column.

30. The puncher as claimed in claim 29, wherein
each one of the at least one closing tab has an inner surface and at least one guiding block formed on and protruding from the inner surface of the closing tab; and
the base body has a guiding groove formed in a periphery of the base body, extending from two sides of a corresponding one of the at least one scrap-releasing hole and slidably holding the at least one guiding block of a corresponding one of the at least one closing tab inside.

31. The puncher as claimed in claim 30, wherein
the base body further has two limiting ribs formed respectively on two ends of the guiding groove; and
the bottom cover has two aligning ribs formed on the bottom cover at positions respectively corresponding to and selectively aligning with the limiting ribs on the base body.

32. The puncher as claimed in claim 20, wherein
the bottom cover has a top and a round receiving recess defined in the top of the bottom cover and having a center;
the at least one scrap-receiving space is located in the receiving recess;
the base body has a round cross section and having a center corresponding to the center of the receiving recess; and
a combination assembly is disposed on the centers of the base body and the receiving recess to rotatably combine the base body with the bottom cover.

33. The puncher as claimed in claim 32, wherein the combination assembly comprises a combining post and a combining recess rotatably combining with the combining post.

34. The puncher as claimed in claim 33, wherein the combining post is resilient and comprises an end and multiple resilient combining hooks formed on the end of the combining post and hooking on an inner surface edge of the combining recess.

35. The puncher as claimed in claim 34, wherein
the combining post is disposed on a bottom of the base body; and
the combining recess is disposed in the receiving recess in the bottom cover.

36. The puncher as claimed in claim 35, wherein
the receiving recess has a combining column formed on and protruding from the center of the receiving recess; and
the combining recess is defined in a top of the combining column.

37. The puncher as claimed in claim 21, wherein
each one of the at least one closing tab has an inner surface and at least one guiding block formed on and protruding from the inner surface of the closing tab; and
the base body has a guiding groove formed in a periphery of the base body, extending from at least one side of a corresponding one of the at least one scrap-releasing hole and slidably holding the at least one guiding block of a corresponding one of the at least one closing tab inside.

38. The puncher as claimed in claim 37, wherein
the base body further has at least one limiting rib formed respectively on at least one end of the guiding groove; and
the bottom cover has at least one aligning rib formed on the bottom cover at position respectively corresponding to and selectively aligning with the at least one limiting rib on the base body.
